(19) United States
(12) Patent Application Publication
(10) Pub. No.: US 2026/0304466 A1
(43) Pub. Date: Oct. 1, 2026

(54) DYNAMIC SITE ALLOCATION OF PROTOCOL LAYER FUNCTIONALITIES

(71) Applicant: Telefonaktiebolaget LM Ericsson (publ), Stockholm (SE)

(72) Inventors: Adrian GARCIA RODRIGUEZ, Paris (FR); Tanguy KERDONCUFF, Ermont (FR); Hassan ISMAIL FAWAZ, Paris (FR)

(21) Appl. No.: 19/477,026

(22) PCT Filed: Apr. 20, 2023
(86) PCT No.: PCT/EP2023/060333

§ 371 Date: Oct. 20, 2025

(51) Int. Cl. H04W 72/542; H04W 72/1273; H04W 72/51

(52) U.S. Cl. CPC H04W 72/542; H04W 72/1273; H04W 72/51

(57) ABSTRACT

Dynamic site allocation of protocol layer functionalities Performance indicators of computational resources of a plurality of sites (51, 52) of a radio access network of a wireless communication network are obtained. Based on the performance indicators, a functionality allocation is adapted. The functionality allocation allocates a first set of radio access functionalities of a first set of one or more protocol layers to a first set of the sites (51, 52) of the wireless communication network and allocates a second set of radio access functionalities of a second set of one or more protocol layers to a second set of the sites (51, 52) of the wireless communication network.

### TECHNICAL FIELD

The present invention relates to methods for controlling operation of a wireless communication network and to corresponding devices, systems, and computer programs.

### BACKGROUND

In wireless communication networks, e.g., based on the 4G (4th Generation) LTE (Long Term Evolution) or 5G (5th Generation) NR technology as specified by 3GPP (3rd Generation Partnership Project), efforts have been made to improve usage efficiency of network processing resources. Such efforts include distribution of signal processing related tasks among centralized units (CUs), distributed units (DUs), and radio units (RUs), which are typically logical entities. Such distribution of signal processing related tasks may in some cases be done according to functionalities associated with different protocol layers of the 3GPP protocol stack.

For example, the open radio access network (O-RAN) Alliance and 3GPP have defined several options of splitting the 3GPP protocol stack. Such options are schematically illustrated in FIG. 1. As illustrated, the 3GPP protocol stack includes, in the order of lower protocol layers to higher protocol layer, an RF (Radio Frequency) layer, a PHY (physical) layer for Fast Fourier Transform (FFT) and IFFT (Inverse Fast Fourier Transform)-denoted as PHY-FFT/IFFT, a PHY sublayer for RE (Resource Element) mapping-denoted as PHY-RE mapper, a High PHY layer, a MAC (Medium Access Control) layer, an RLC (Radio Link Control) layer, and a PDCP (Packet Data Convergence Protocol) layer. Depending on the splitting points, different parts of the protocol stack are implemented at the RU, the DU, or the CU. In a protocol split denoted as “Split 8”, the functionalities of the RF layer are assigned to the RU, the functionalities of the PHY-FFT/IFFT layer, of the PHY-RE mapper layer, of the High PHY layer, of the MAC layer, and of the RLC layer are assigned to the DU, and the functionalities of the PDCP layer are assigned to the CU. In a protocol split denoted as “Split 7.1”, the functionalities of the RF layer and of the PHY-FFT/IFFT layer are assigned to the RU, the functionalities of the PHY-RE mapper layer, of the High PHY layer, of the MAC layer, and of the RLC layer are assigned to the DU, and the functionalities of the PDCP layer are assigned to the CU. In a protocol split denoted as “Split 7.2”, the functionalities of the RF layer, of the PHY-FFT/IFFT layer, and of the PHY-RE mapper are assigned to the RU, the functionalities of the High PHY layer, of the MAC layer, and of the RLC layer are assigned to the DU, and the functionalities of the PDCP layer are assigned to the CU. In a protocol split denoted as “Split 6”, the functionalities of the RF layer, of the PHY-FFT/IFFT layer, of the PHY-RE mapper, and of the High PHY layer are assigned to the RU, the functionalities of the MAC layer and of the RLC layer are assigned to the DU, and the functionalities of the PDCP layer are assigned to the CU. In a protocol split denoted as “Split 5”, the functionalities of the MAC layer are further split into HARQ (Hybrid Automatic Repeat Request) layer-denoted as MAC HARQ and a High MAC layer. In the case of Split 5, functionalities of the RF layer, of the PHY-FFT/IFFT layer, of the PHY-RE mapper, of the High PHY layer, and of the MAC HARQ layer are assigned to the RU, the functionalities of the High MAC layer and of the RLC layer are assigned to the DU, and the functionalities of the PDCP layer are assigned to the CU. It should be noted that the throughput of the interfaces among different units, i.e., between RU and DU and between DU and CU, typically has a significant dependence on the chosen splitting points. A discussion of such protocol splits can also be found in “A Survey of the Functional Splits Proposed for 5G Mobile Crosshaul Networks”, by L. M. P. Larsen, A. Checko and H. L. Christiansen, IEEE Communications Surveys & Tutorials, vol. 21, no. 1, pp. 146-172, Firstquarter 2019 (October 2018).

In “Flexible RAN: Combining Dynamic Baseband Split Selection and Reconfigurable Optical Transport to Optimize RAN Performance”, by Y. Li et al., IEEE Network, vol. 34, no. 4, pp. 180-187, July/August 2020 (April 2020), a Flexible-RAN (F-RAN) architecture is proposed, where an orchestrator adapts a split of functionalities among i) physical RUs, ii) a metro node located at an aggregation site, and iii) a metro edge located at a central site. The adaptation is accomplished depending on the radio performance requirements and the availability of transport resources among nodes. While such dynamic splitting may improve performance over a fixed split, only a limited number of different splitting options are considered. Such known splitting approaches may for example experience difficulties in scenarios where infrastructure implementing the DU fails or becomes overloaded. Moreover, the known splitting approaches offer limited capabilities to consider aspects of resource cost or power consumption.

Accordingly, there is a need for techniques which allow for more efficiently controlling splitting of protocol layer functionalities in a wireless communication network.

### SUMMARY

According to an embodiment, a method of controlling operation of a wireless communication network is provided. The method comprises obtaining performance indicators of computational resources of a plurality of sites of a radio access network of the wireless communication network. Based on the performance indicators, a functionality allocation is adapted. The functionality allocation allocates a first set of radio access functionalities of a first set of one or more protocol layers to a first set of the sites of the wireless communication network and allocates a second set of radio access functionalities of a second set of one or more protocol layers to a second set of the sites of the wireless communication network.

According to a further embodiment, a node for a wireless communication network is provided. The node is configured to obtain performance indicators of computational resources of a plurality of sites of a radio access network of the wireless communication network. Further, the node is configured to, based on the performance indicators, adapt a functionality allocation which allocates a first set of radio access functionalities of a first set of one or more protocol layers to a first set of the sites of the wireless communication network and allocates a second set of radio access functionalities of a second set of one or more protocol layers to a second set of the sites of the wireless communication network.

According to a further embodiment, a node for a wireless communication network is provided. The node comprises at least one processor and a memory. The memory contains instructions executable by said at least one processor, whereby the node is operative to obtain performance indicators of computational resources of a plurality of sites of a radio access network of the wireless communication network. Further, the memory contains instructions executable by said at least one processor, whereby the node is operative to, based on the performance indicators, adapt a functionality allocation which allocates a first set of radio access functionalities of a first set of one or more protocol layers to a first set of the sites of the wireless communication network and allocates a second set of radio access functionalities of a second set of one or more protocol layers to a second set of the sites of the wireless communication network.

According to a further embodiment of the invention, a computer program or computer program product is provided, e.g., in the form of a non-transitory storage medium, which comprises program code to be executed by at least one processor of a node for a wireless communication network. Execution of the program code causes the node to obtain performance indicators of computational resources of a plurality of sites of a radio access network of the wireless communication network. Further, execution of the program code causes the node to, based on the performance indicators, adapt a functionality allocation which allocates a first set of radio access functionalities of a first set of one or more protocol layers to a first set of the sites of the wireless communication network and allocates a second set of radio access functionalities of a second set of one or more protocol layers to a second set of the sites of the wireless communication network.

Details of such embodiments and further embodiments will be apparent from the following detailed description of embodiments.

### BRIEF DESCRIPTION OF THE DRAWINGS

FIG. 1 schematically illustrates options of splitting a protocol stack as considered in embodiments of the present disclosure.

FIG. 2 schematically illustrates a wireless communication network according to an embodiment of the present disclosure.

FIG. 3 schematically illustrates an example procedure for adaptation of a protocol stack split according to an embodiment of the present disclosure.

FIG. 4 schematically illustrates a further example procedure for adaptation of a protocol stack split according to an embodiment of the present disclosure.

FIGS. 5A and 5B illustrate an example of adaptation of a protocol stack split according to an embodiment of the present disclosure.

FIG. 6 schematically illustrates a procedure underlying the example of FIGS. 5A and 5B.

FIG. 7 schematically illustrates a sub-procedure of the procedure of FIG. 6.

FIGS. 8A, 8B, and 8C illustrate a further example of adaptation of a protocol stack split according to an embodiment of the present disclosure.

FIG. 9 schematically illustrates a procedure underlying the example of FIGS. 8A, 8B, and 8C.

FIG. 10 schematically illustrates a sub-procedure of the procedure of FIG. 9.

FIG. 11 illustrates selection options of protocol splits in an embodiment of the present disclosure.

FIGS. 12A, 12B, and 12C illustrate an further example of adaptation of a protocol stack split according to an embodiment of the present disclosure.

FIG. 13 schematically illustrates a procedure underlying the example of FIGS. 12A, 12B, and 12C.

FIG. 14 shows a flowchart for schematically illustrating a method according to an embodiment.

FIG. 15 schematically illustrates structures of a network node according to an embodiment.

FIG. 16 schematically illustrates interaction of a host and a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling operation of a wireless communication network, in particular for controlling splitting of functionalities of different protocol layers. The wireless communication network may be based on the 5G NR technology specified by 3GPP. However, other technologies could be used as well, e.g., the 4G LTE technology specified by 3GPP or a future 6G (6 th Generation) technology. The protocol layers may thus correspond to layers of the 3GPP protocol stack.

In the illustrated concepts, allocation of radio access functionalities of different protocol layers to sites of the wireless communication network is adapted depending on performance indicators of computational resources at the different sites. The computational resources may be part of cloud infrastructure. Accordingly, protocol stack functionalities, e.g., assigned to one or more DUs and/or to one or more CUs, may dynamically vary their location based on the performance indicators. The performance indicators will in the following also be denoted as KPIs (key performance indicators). The KPIs may for example represent performance of one or more CPUs (Central Processing Units), performance of one or more GPUs (Graphics Processing Units), and/or of one or RAM (Random Access Memory) devices at the respective site. The sites may correspond to central sites or to aggregation sites. By adapting the allocation, the locations where the protocol stack functionalities executed can be optimized, e.g., in view of network performance, energy consumption, resource costs, or the like. This may allow for utilizing the cloud infrastructure in a more efficient manner.

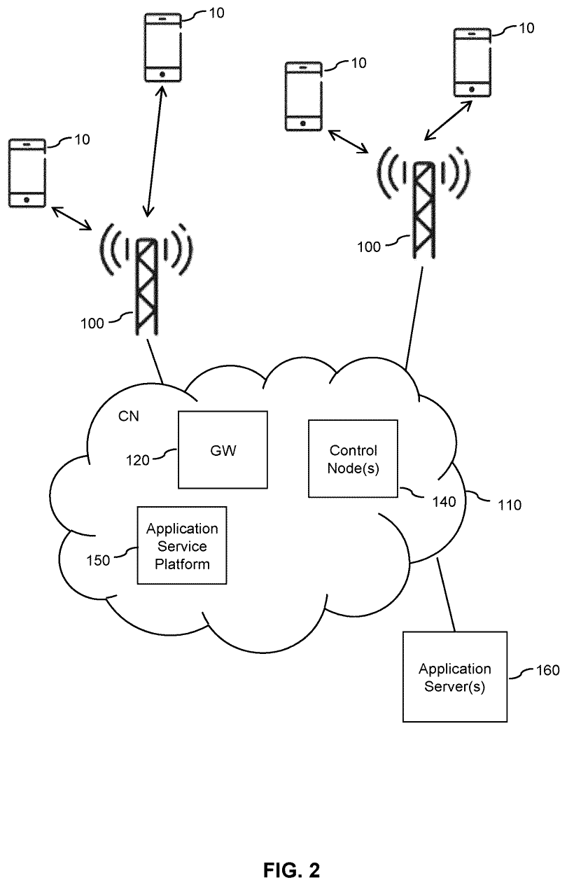

FIG. 2 illustrates exemplary structures of the wireless communication network. In particular, FIG. 2 shows UEs 10 which are served by access nodes 100 of the wireless communication network. Here, it is noted that the wireless communication network may actually include a plurality of access nodes 100 that may serve a number of cells within the coverage area of the wireless communication network.

The access nodes 100 may be regarded as being part of an RAN of the wireless communication network. Further, FIG. 2 schematically illustrates a CN (Core Network) 110 of the wireless communication network. In FIG. 2, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may for example be used for controlling the user data traffic, e.g., by providing control data to the access node 100, the GW 120, and/or to the UE 10.

As illustrated by solid double-headed arrows, the access node 100 may send DL wireless transmissions to at least some of the UEs 10, and some of the UEs 10 may send UL wireless transmissions to the access node 100.

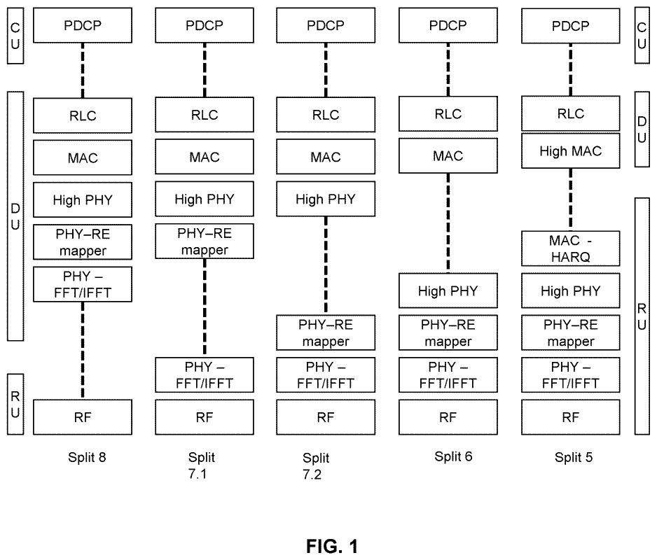

The DL transmissions and UL transmissions may be used to provide various kinds of services to the UEs 10, e.g., a voice service, a multimedia service, or some other data service. Such services may be hosted in the CN 110, e.g., by a corresponding network node. By way of example, FIG. 2 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110.

The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user data traffic conveyed by the DL transmissions and/or the UL transmissions between the access node 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the user plane data traffic between the UEs 10 and the access node 100.

In the illustrated concepts, the RAN, e.g., the access nodes 100 and related transport infrastructure may be implemented based on RUs, DUs, and CUs, using cloud infrastructure spanning different physical sites, i.e., different locations. Functionalities of different protocol layers, e.g., of the 3GPP protocol stack as explained in connection with FIG. 1, may be split and either be performed by a RU, a DU, or a CU, which in turn may be implemented by infrastructure of different sites. The allocation of the functionalities of a certain protocol layer to one or more of the sites is adapted in a dynamic manner, based on the KPIs of the computational resources at the sites.

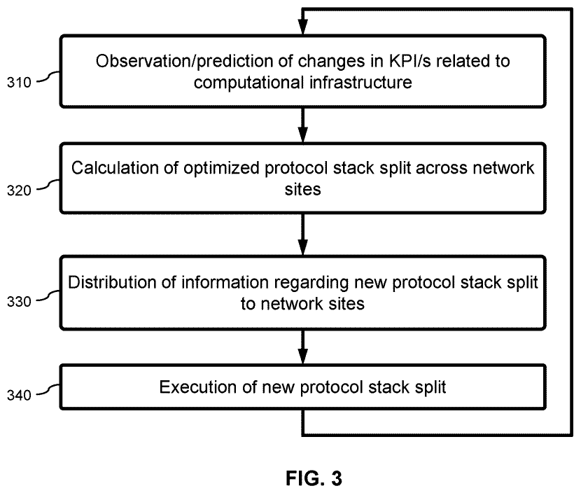

FIG. 3 schematically illustrates an adaptation procedure in accordance with the illustrated concepts. The adaptation procedure may be managed by a split controller, but it is noted that parts of the procedure could also be implemented at other network nodes, e.g., nodes which implement the allocated functionalities at the respective sites of the wireless communication network. Such split controller could be implemented by a node of the RAN, e.g., a node which also implements functionalities of one or more of the access nodes 100, or a node of the CN 110, e.g., one of the control nodes 140. In some cases, the split controller could be implemented by a cloud application executed by multiple nodes of the RAN. As mentioned above, the split controller may be used to dynamically optimize the location at which functionalities corresponding to the different layers of the protocol stack are implemented. This may be accomplished layers based on information gathered from one or more monitoring functions. The monitoring functions may for example monitor information related to power consumption of the computational infrastructure at the considered sites of the wireless communication network, resource availability of the computational infrastructure at the considered sites of the wireless communication network, load of the computational resources at the considered sites of the wireless communication network, downtimes of the computational infrastructure at the considered sites of the wireless communication network, and/or pricing of the computational infrastructure at the considered sites of the wireless communication network.

In the procedure of FIG. 3, block 310 involves observation and/or prediction of changes of KPI(s) related to the computational infrastructure at the considered sites. The observation of the KPI(s) may be based on reports of observed KPI values from the respective sites. The prediction of the changes of the KPI(s) may in turn be based on an ML (machine learning) model. Such ML model may in turn be trained based on reported observed KPI values.

At block 320, the observations and/or predictions from block 310 are used for calculating an optimized split of the protocol stack. This optimization may involve changing the allocation of the functionalities corresponding to a certain protocol layer from one site to another site. In addition, the optimization may also involve changing the splitting points, such as from Split 8 to Split 7.1. Further details of methods which may be used for such optimization will be explained below.

At block 330, information concerning the optimized split from block 320 is distributed to the relevant sites of the wireless communication network. This may involve various kinds of signaling towards the sites, e.g., indicating that new protocol stack layers are to be executed, indicating that execution of certain protocol layers is to be stopped, and/or indicating how protocol stack data should be rerouted.

At block 340, the optimized split of the protocol stack is executed. This involves executing the functionalities of the different protocol layers at the sites to which they are allocated by the optimized split and routing the protocol stack data accordingly.

The adaptation procedure of FIG. 3 may be repeated in an iterative manner to successively further optimize the split and/or to dynamically consider changes in the observed KPI(s).

Accordingly, the split controller may dynamically decide at which sites the different protocol stack layers are executed. In this way, overall operation of the wireless communication network may be optimized with respect to the observed KPIs for the computational infrastructure at the considered sites. Such optimization may address various scenarios. For example, in a scenario where the functionalities of the protocol stack are implemented by a DU and a CU at different sites, the observed KPI(s) could indicate failure or a risk of failure of the infrastructure implementing the DU. To avoid that the RU(s) connected to the DU become inoperative, the optimization could re-allocate the functionalities of the protocol stack which are implemented by the DU to one or more other sites. In another scenario, the observed KPI(s) could indicate an overload or a risk of an overload of the computational infrastructure implementing several DUs. Such overload could for example be due to adding a larger number of DUs, e.g., because new RUs are deployed at a given location. The optimization could re-allocate the functionalities of the protocol stack which are implemented by the DUs to additional sites. In further scenarios, the optimization may consider differences in power consumption of the computational infrastructure. For example, different computational nodes are typically equipped with different hardware and may be located at in different spatial regions. Here, it could be taken into account that optimization of power consumption computational infrastructure at a large centralized site, e.g., a server farm, could be easier than for a smaller aggregation site, e.g., a local server cluster. In a further example, it could be considered that even if the power consumption of executing a given functionality is larger at site where the computational infrastructure is solar powered, allocating the functionality to this site may bel preferable in view of energy efficiency. In further scenarios, the optimization may consider differences in pricing of the computational infrastructure. Here, it may be taken into account that the same kind computational resources, however deployed at different sites, may have different monetary cost and and that such monetary cost may vary over time. For instance, during the night GPU utilization at sites where the DUs are located may be cheaper than GPU utilization at sited where the CUS are located, but during the day, the situation could be the opposite. Such changes in pricing could for example be due to usage of GPUs at the CUs for ML training during the night.

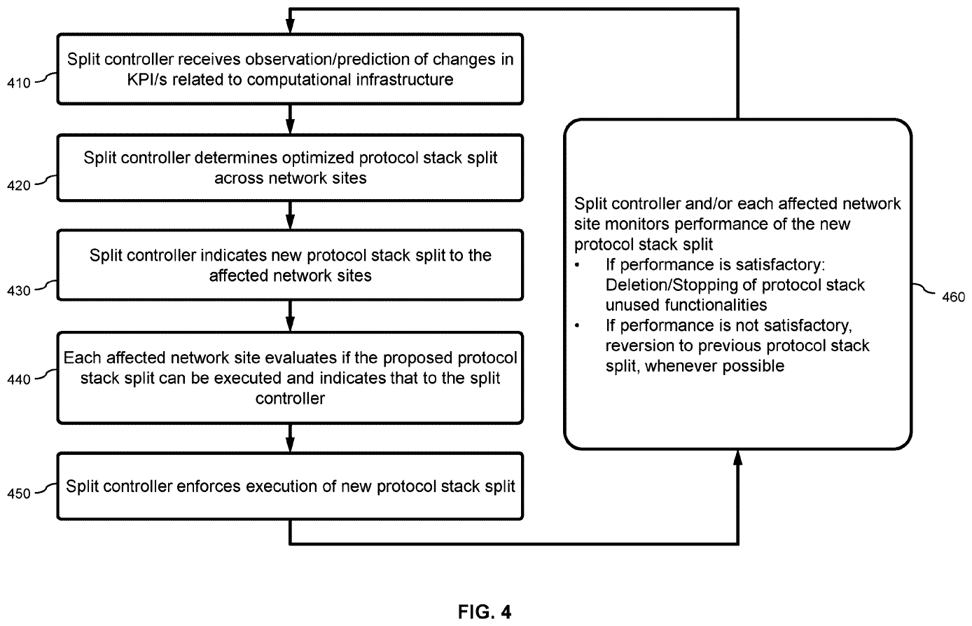

FIG. 4 schematically illustrates a further adaptation procedure in accordance with the illustrated concepts. The adaptation procedure of FIG. 4 is generally similar to that of FIG. 3, but includes some further steps for evaluation and performance checks.

In the procedure of FIG. 4, block 410 involves observation and/or prediction of changes of KPI(s) related to the computational infrastructure at the considered sites. The observation of the KPI(s) may be based on reports of observed KPI values from the respective sites. The prediction of the changes of the KPI(s) may in turn be based on an ML model. Such ML model may in turn be trained based on reported observed KPI values.

At block 420, the observations and/or predictions from block 310 are used for determining an optimized split of the protocol stack. This optimization may involve changing the allocation of the functionalities corresponding to a certain protocol layer from one site to another site.

At block 430, the split controller indicates information concerning the optimized split from block 320 to the relevant sites of the wireless communication network. This may involve various kinds of signaling towards the sites, e.g., indicating that new protocol stack layers are to be executed, indicating that execution of certain protocol layers is to be stopped, and/or indicating how protocol stack data should be rerouted.

At block 440, evaluation procedures are performed at the respective sites of the wireless communication network. Such evaluation procedures may be to evaluate whether execution of new protocol stack layers is feasible at the site and/or whether rerouting of protocol stack data is feasible. Results of such evaluations may be signaled from the sites to the split controller.

At block 450, the split controller enforces the optimized split of the protocol stack. This involves executing the functionalities of the different protocol layers at the sites to which they are allocated by the optimized split and routing the protocol stack data accordingly, provided that this was found to be feasible at block 440. Block 450 may also involve instantiating protocol stack layers in accordance with the information provided by the split controller.

At block 460, the split controller and/or the respective sites may monitor the performance achieved based on the new split of the protocol stack, e.g., based on the same KPI(s) as monitored at block 410. If the performance is found to be satisfactory, protocol stack layers no longer used at a given site may be stopped and/or deleted. If the performance is not found to be satisfactory, the split controller may consider reverting to the previous version of the split.

The adaptation procedure of FIG. 4 may be repeated in an iterative manner to successively further optimize the split and/or to dynamically consider changes in the observed KPI(s).

In the following, further details of the illustrated concepts will be explained by referring to exemplary scenarios in which the dynamic adaptation of the allocation of protocol layer functionalities may provide significant benefits.

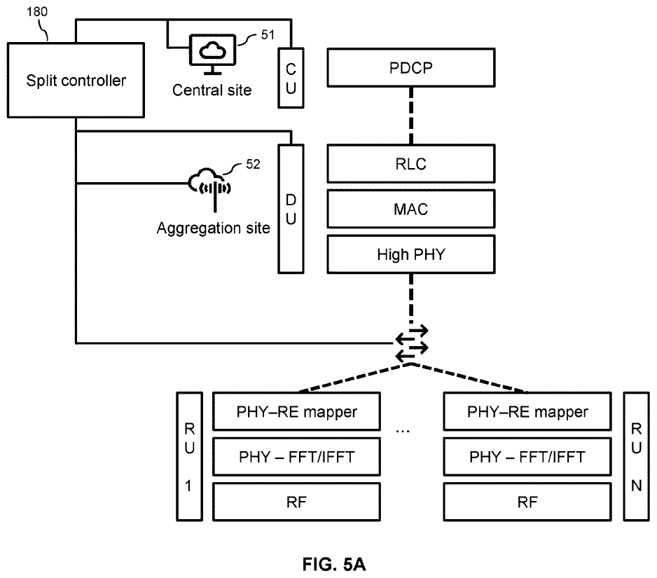

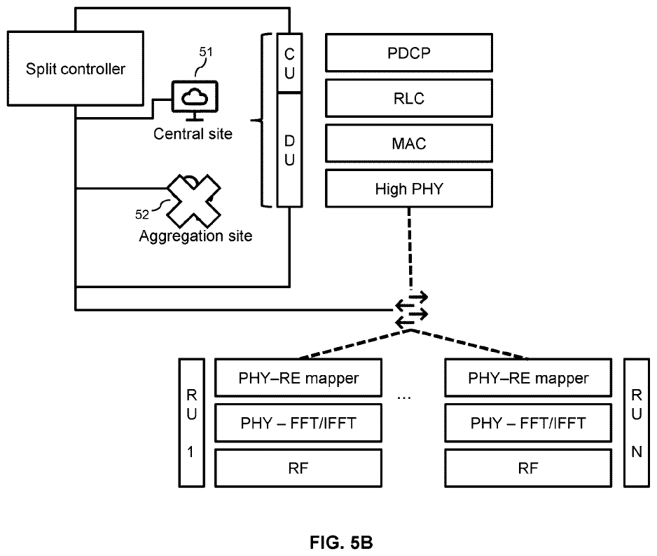

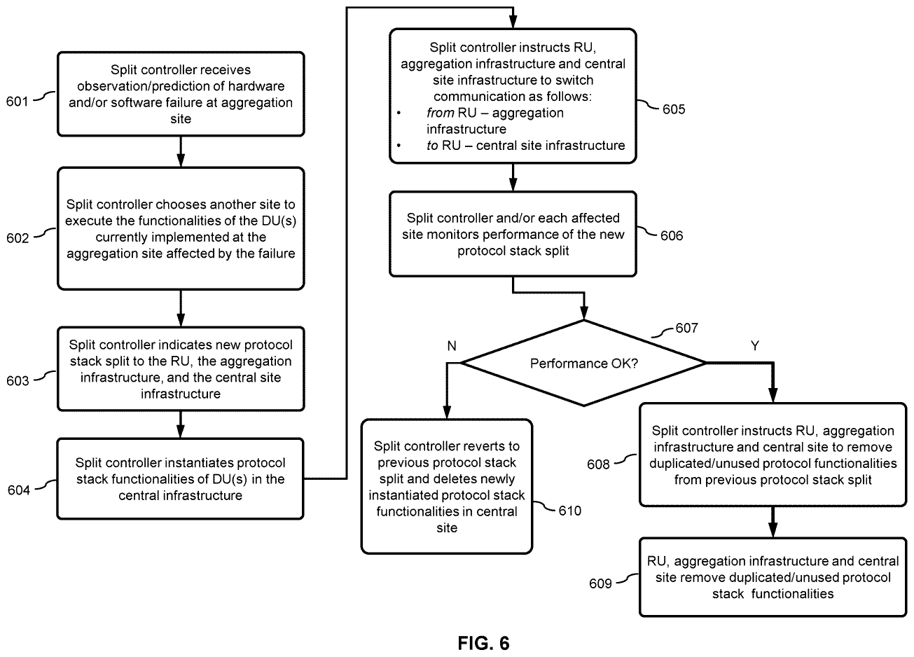

In a first example, a scenario is considered where there is a risk of disturbance in network data traffic due to downtime of the computational infrastructure at a site. The allocation of functionalities may initially be as illustrated in FIG. 5A, with functionalities of the High PHY layer, of the MAC layer and of the RLC layer being executed by a DU at an aggregation site 52 and functionalities of the PDCP layer being executed by a CU at a central site 51. Functionalities of the RF layer, of the PHY-FFT/IFFT layer, and of the PHY-RE mapper layer are located at a number of RUs (denoted as RU 1-RU N). Based on the monitoring of the KPI(s), the split controller 180 predicts that there is a risk that the aggregation site infrastructure will experience a failure of hardware and/or software. In response, the split controller 180 moves the protocol stack functionalities executed by the DU at the aggregation site 52 to the central site 51, as illustrated in FIG. 5B. After this adaptation of the allocation of functionalities to the sites, the functionalities of the High PHY layer, of the MAC layer and of the RLC layer are thus executed by a DU at the central site 51. Once the failure is resolved, the split controller 180 may decide to revert to the original allocation of functionalities as illustrated by FIG. 5A. FIG. 6 schematically illustrates a procedure underlying the scenario of the first example.

At block 601 of FIG. 6, the split controller 180 receives an observation or prediction of a failure of hardware and/or software of the aggregation site infrastructure. Receiving the observation or prediction may involve that the split controller 180 periodically receives measurements of one or more KPIs related to the hardware and/or software of the relevant site infrastructure, e.g., related to temperature of hardware, circuitry measurements, network connectivity, or the software status reports. Here, the network connectivity may refer to, e.g., the network interfaces or network cabling for inter-connection of distinct protocol stack layers executed in different infrastructure entities. In some scenarios, the split controller 180 may receive such KPI(s) in response to a request. Alternatively or in addition, infrastructure at the respective site could decide autonomously to report such KPI(s), e.g., based on a configuration provided by the split controller 180. Such autonomous reporting of KPI(s) could for example be triggered when a set of one or more predetermined conditions is met, e.g., a sudden increase in the temperature at the site, degradation and/or overloading of the network connectivity, or the like. In some scenarios, in response to sending a request, the split controller 180 may receive an indication of a potential failure within the aggregation site 52 from other sites which executing the remaining parts of the protocol stack, e.g., from sites at which the RUs are implemented or from the central site 51 where the CU is implemented. The infrastructure at the RU sites and/or the infrastructure of the central site 51 may detect such potential failure based on anomalies in communication with the infrastructure of the aggregation site 52, e.g., missing receipt of an acknowledgement after the transmission of protocol stack data to the aggregation site 52 and/or a lack of receipt of protocol stack data for a certain time, e.g., for duration larger than a predetermined or configured threshold time. In some scenarios, an ML model may be used to predict the failure. Such ML model could for example be based on a time series forecasting model. Suitable models are for example described in “A Survey on Hardware Failure Prediction of Servers Using Machine Learning and Deep Learning”, by N. Georgoulopoulos et al., 2021 10th International Conference on Modern Circuits and Systems Technologies (MOCAST) (2021). Such ML model could be executed as a functionality which is independent of the split controller 180, e.g., a separate cloud application, and its output could be provided as input to the split controller 180. Alternatively, the ML model could be a functionality within the split controller 180.

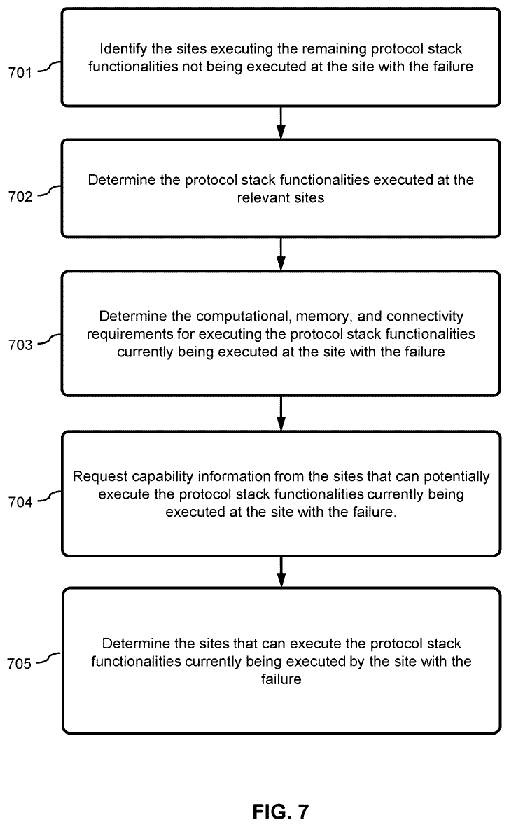

At block 602, the split controller 180 chooses another site to instantiate the functionalities of DU(s) currently implemented at the aggregation site 52 affected by the failure and adapts the split of the protocol stack accordingly. Possible details of a corresponding procedure are explained in connection with FIG. 7.

At block 603, the split controller 180 indicates the adapted split and functionality allocation of the protocol stack to the RUs, the infrastructure of the aggregation site 52, and the infrastructure of the central site 51, and at block 604, the split controller 180 instantiates functionalities of the DU(s) in the infrastructure of the central site 51.

At block 605, the split controller 180 initiates switching of communication paths between different entities of the relevant infrastructure. In particular, the split controller 180 initiates re-re-routing of communication between the infrastructure of the RU sites and infrastructure of the aggregation site 52 to communication between the infrastructure of RU sites and infrastructure of the central site 51 (e.g., as illustrated in FIG. 5B).

At block 606, the split controller 180 and/or each affected site may monitor performance of the adapted split and, at block 607, check if the performance is acceptable. If the performance is found to be acceptable, the split controller 180 may proceed to block 608, as indicated by branch “Y”. At block 608, the split controller 180 may instruct the infrastructure at the RU sites, the infrastructure at the aggregation site 52, and the infrastructure at the central site 51 to remove duplicated or otherwise unused protocol functionalities, which may remain from the previous split of the protocol stack. At block 609, the infrastructure at the RU sites, the infrastructure at the aggregation site 52, and the infrastructure at the central site 51 act accordingly and remove the duplicated or unused functionalities. If the check of block 607 reveals that the performance is not acceptable, the split controller 180 may revert to the previous split of the protocol stack and delete newly instantiated protocol stack functionalities at the central site 51.

FIG. 7 further illustrates the selection of the site to instantiate the functionalities of the DU(s) currently implemented at the aggregation site 52 affected by the failure. In the example of FIGS. 5A and 5B, the selected site would be the central site 51. This determination can be made with the aim of avoiding disruption of the protocol data traffic. The procedures illustrated by FIG. 7 may be performed as sub-procedures of above-mentioned block 602.

At block 701, the split controller 180 identifies the sites executing the remaining protocol stack functionalities which are not being executed by the site with the failure. In the example of FIGS. 5A and 5B, this would involve identifying the sites where the CU and the RUs are implemented. For this purpose, the split controller 180 could receive a message from the site with the failure, indicating for each of the protocol stack functionalities being executed, the nodes or other infrastructure entities executing the remaining protocol stack functionalities. Such infrastructure entities may correspond to those which communication protocol data traffic with the infrastructure of the site with the failure. The message could for example be received immediately after the initialization of a new protocol stack or a split change, which could also be controlled by another entity than the split controller 180. Further, such message could be received in response to a corresponding request from the split controller 180. Further, the split controller 180 could send a message to all sites, requesting to indicate whether infrastructure of the respective site executes the protocol stack functionalities which are complementary to those executed at the site with the failure. This could for example be performed when the affected site is no longer responsive due to the failure.

At block 702, the split controller 180 determines the protocol stack functionalities executed at the relevant sites. In the considered example, these would include at least the central site 51 and the aggregation site 52. This may correspond to identifying which split option is currently being applied. For this purpose, the split controller 180 may send a request message to the relevant sites currently executing the protocol stack functionalities and/or which are planned to execute the protocol stack functions. In some cases, the split controller 180 may periodically send such request message, or the request message could instruct the relevant sites to periodically report the protocol stack functionalities currently being executed and/or planned to be executed. In some cases, the split controller 180 could send a request message to the relevant sites, instructing the sites to report any changes concerning the executed protocol stack functionalities, such as new protocol stack functionalities added due to setting up of new base stations. In some cases, the split controller 180 could also use the signaling of block 701 to determine the protocol stack functionalities currently executed or planned to be executed by the relevant sites. In this case, the signaling of block 701 could be supplemented by corresponding information.

At block 703, the split controller 180 uses the information obtained from block 702 to determine computational requirements, memory requirements, and connectivity requirements for executing the protocol stack functionalities currently being executed at the site with the failure. In the considered example, this may involve identifying the requirements to execute the layers originally executed by the DU at the aggregation site 52, e.g., the functionalities of the RLC layer, MAC layer, and high PHY layer. The determination of the computational and memory requirements may for example be based on a look-up table or other database available at the split controller 180, indicating the requirements for executing a given protocol stack layer. In some cases, the requirements may correspond to requirements to implement specifications provided by 3GPP and/or O-RAN.

The determination of the connectivity requirements may consider to a maximum latency and the minimum throughput permitted between the lowest protocol stack functionality to be executed, in the considered example the High PHY layer, and the immediately lower protocol stack functionalities, in the considered example the PHY-RE mapper layer. Once the involved protocol stack functions/layers are identified, the connectivity requirements may be obtained by, e.g., from a look-up table or other database. Such look-up table or database may store previously computed connectivity requirements for all possible split options.

At block 704, the split controller 180 requests capability information from those sites which could potentially execute the protocol stack functionalities of the site with the failure, herein also denoted as candidate sites. If the site with the failure is an aggregation site 52, like in the illustrated example, the candidate sites could be one or more other aggregation sites 52 or one or more central sites 51. In some cases, the split controller 180 could request the capability information from all sites. In other cases, the split controller 180 could request the capability information from only the sites identified at block 701. The capability information may for example indicate available computational resources and/or available memory resources, in terms of current availability and/or availability during the expected failure. Further, the capability information may indicate latency and/or throughput of the links connecting the candidate site with the sites relevant RUs executing parts of the protocol stack, i.e., the RU sites identified at block 701. To acquire the capability information, the split controller 180 may send a request message to the candidate sites. In some cases, the split controller 180 may periodically send such request message, or the request message could instruct the candidate sites to periodically report the capability information. In some cases, the split controller 180 could send a request message to the candidate sites, instructing the sites to report any changes concerning the capability information. In some cases, the split controller 180 could also use the signaling of block 701 to determine the capability information. In this case, the signaling of block 701 could be supplemented by corresponding information.

At block 705, the split controller 180 determines the site(s) to execute the protocol stack functionalities of the site affected by the failure. For this purpose, the split controller 180 first identifies the candidate sites that satisfy the computational requirements, memory requirements, and connectivity requirements determined at block 703. This may involve comparing the capability information obtained at block 704 to the requirements determined at block 703. If there is only a single candidate site that satisfies the requirements, this candidate site be selected and the selection procedure finished.

If there are multiple candidate sites that satisfy the requirements, the split controller 180 may further select a single site among these multiple candidate sites, e.g., based on one or more of the following criteria: In some cases, the split controller 180 could select the candidate site with the most available resources. Here, the available resources may refer to computational resources, memory resources, connectivity resources, and/or to a combination of two or more of such resource types. In some cases, the split controller 180 could select the candidate site which is least prone to failures, i.e., is most reliable. A reliability metric indicting how prone to failures a site is may for example be computed by evaluating past downtimes of the sites. In some cases, the split controller 180 could select the candidate site with the smallest economic cost. The economic cost may for example refer to current or expected monetary costs to execute the protocol stack functionalities, typically also taking into account the occupation of connectivity resources. In some cases, the split controller 180 could select the candidate site with the smallest power consumption when executing the protocol stack functionalities. In some cases, the split controller 180 could select the candidate site randomly. Further, the selection could be based on a combination of two or more of the above criteria, e.g., by using a multi-stage selection process where each stage applies a different criterion, or by defining a selection metric which considers the criteria in combination, such as a weighted combination of two or more of the individual metrics underlying the criteria. In some scenarios, the criterion or the criteria to be applied may be configurable, e.g., by the operator of the wireless communication network. For determination of one or more of the metrics considered in the selection, the split controller 180 may also request additional information from the candidate sites.

In scenarios with imminent failure at a network site, procedures as explained in connection with FIGS. 6 and 7 may help to avoid the disturbance of the network traffic by anticipating the failure, or at least quickly detecting the failure, and moving execution of the potentially affected protocol stack functionalities to one or more other network sites which are not affected by the failure, and re-routing the protocol data traffic according to the modified allocation of protocol stack functionalities to network sites.

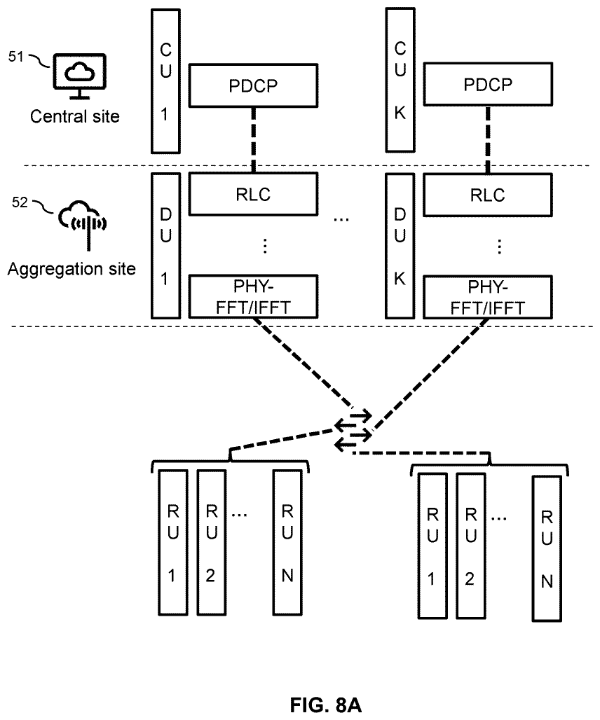

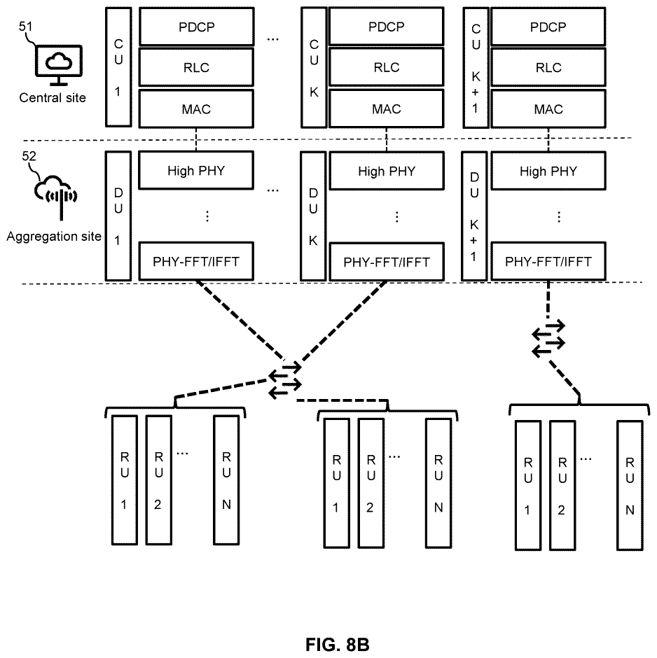

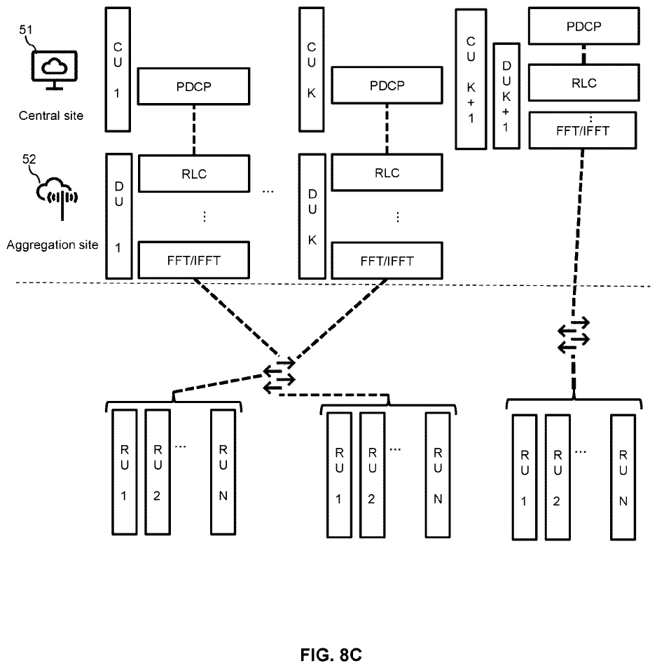

In a second example, a scenario involving load balancing over different sites is considered. In particular, there may be situations where computational resources at a given site may be limited, e.g., because new RUs are being added in the same region and a new DU may be required to be instantiated. FIGS. 8A, 8B, and 8C illustrate an example of how such a scenario may be addressed based on the illustrated concepts.

The allocation of functionalities may initially be as illustrated in FIG. 8A, with functionalities of the PHY-FFT/IFFT layer to RLC layer being implemented by a number of DUs (denoted as DU 1-DU K) at one or more aggregation sites 52, and functionalities of the PDCP layer being executed by a number of CUs (denoted as CU 1-CU K) at one or more central sites 51. Functionalities of the RF layer, of the PHY-FFT/IFFT layer, and of the PHY-RE mapper layer are located at multiple sets of RUs (each including multiple RUs denoted as RU 1-RU N). In the figure, each set of vertically aligned CU, DU and set of RUs denotes an independent protocol stack.

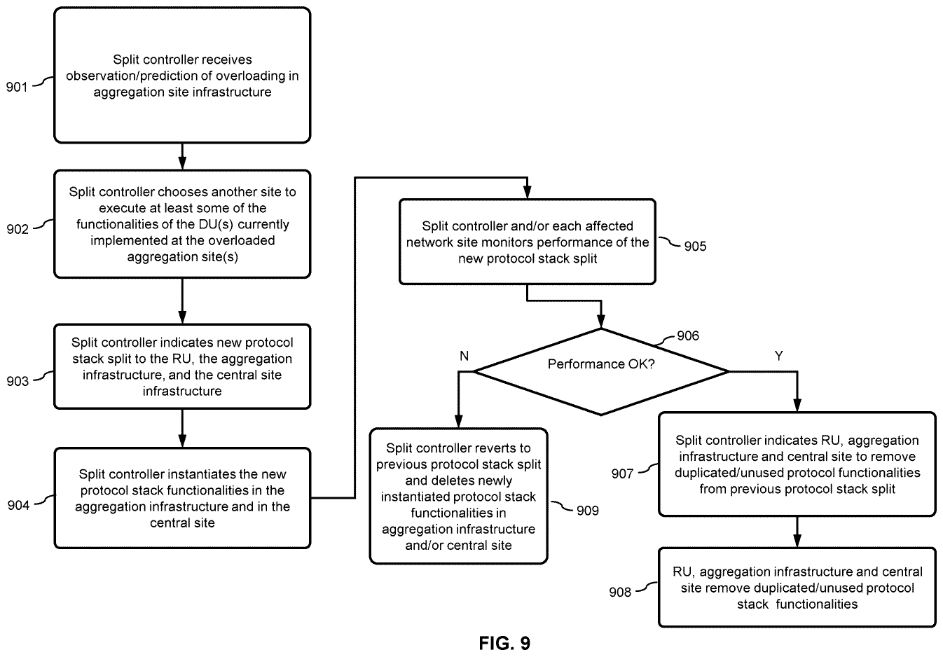

Based on the monitoring of the KPI(s), the split controller detects that the computational resources of the infrastructure of the aggregation site(s) 52 may be limited, the split controller moves some of the protocol stack functionalities executed by the multiple DUs at the to the central site infrastructure and implements an additional DU in the aggregation site infrastructure and an additional CU in the central site infrastructure, as illustrated in FIG. 8B. In particular, the protocol stack functionalities of the RLC layer and of the MAC layer are moved from the DUs at the aggregation site(s) 52 to the CUs at the central site(s) 51. FIG. 8C shows an alternative way of moving the respective functionalities to the central site infrastructure. In the variant of FIG. 8C, an additional DU which implements the functionalities of the PHY-FFT/IFFT layer to RLC layer is implemented at the central site infrastructure. The variant of FIG. 8B may however be preferable over that of FIG. 8C because there might be limitations in throughput of the transport network between the RUs and the central site infrastructure and because execution of protocol functionalities of the lower layers (such as PHY-FFT/IFFT and PHY-RE mapper) at the central site infrastructure could make it more challenging to meet latency requirements. FIG. 9 schematically illustrates a procedure underlying the scenario of the second example.

At block 901 of FIG. 9, the split controller receives an observation or prediction of a overloading of hardware of the aggregation site infrastructure. Receiving the observation or prediction may involve that the split controller periodically receives measurements of one or more KPIs related to the hardware and/or software of the relevant site infrastructure, e.g., related to temperature of hardware, circuitry measurements, network connectivity, or the software status reports. Again, the network connectivity may refer to, e.g., the network interfaces or network cabling for inter-connection of distinct protocol stack layers executed in different infrastructure entities. In some scenarios, the split controller may receive such KPI(s) in response to a request. Alternatively or in addition, infrastructure at the respective site could decide autonomously to report such KPI(s), e.g., based on a configuration provided by the split controller. Such autonomous reporting of KPI(s) could for example be performed according to a periodic schedule or be triggered when a set of one or more predetermined conditions is met, e.g., computational load of the site exceeding a given percentage of the available computational resources, or the like. In the considered example, block 901 specifically involves determining that the computational resources of the aggregation site 52 are subject to a limitation which may result in overloading. In some cases, such identification may be based on a corresponding indication from the site, e.g., based on a KPI indicating overloading. Such KPI could for example be sent when a new DU needs to be instantiated but no computational resources are available to perform the instantiation.

In some scenarios, an ML model may be used to predict the overload. Such ML model could for example be based on a time series forecasting model. Such ML model may be similar to that as used in the first example.

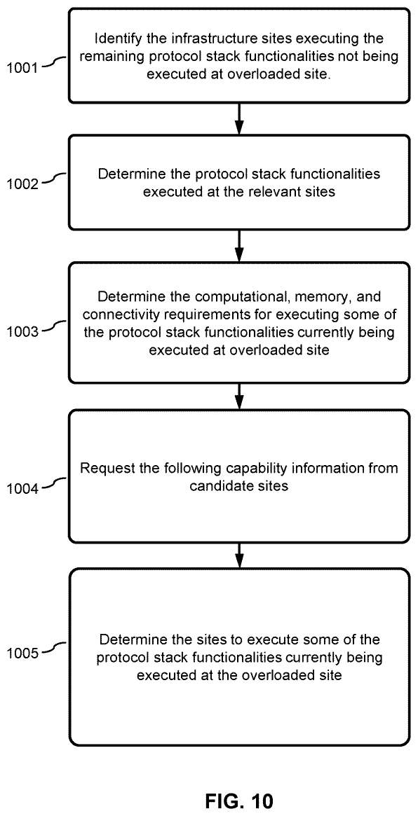

At block 902, the split controller chooses another site to instantiate at least some of the functionalities of DU(s) currently implemented at the overloaded aggregation site 52 and adapts the split of the protocol stack accordingly. Possible details of a corresponding procedure are explained in connection with FIG. 10.

At block 903, the split controller indicates the adapted split and functionality allocation of the protocol stack to the RUs, the infrastructure of the aggregation site 52, and the infrastructure of the central site 51, and at block 904, the split controller instantiates protocol stack functionalities of the DU(s) in the infrastructure of the central site 51.

At block 905, the split controller and/or each affected site may monitor performance of the adapted split and, at block 905, check if the performance is acceptable. If the performance is found to be acceptable, the split controller may proceed to block 906, as indicated by branch “Y”. At block 906, the split controller may instruct the infrastructure at the RU sites, the infrastructure at the aggregation site 52, and the infrastructure at the central site 51 to remove duplicated or otherwise unused protocol functionalities, which may remain from the previous split of the protocol stack. At block 907, the infrastructure at the RU sites, the infrastructure at the aggregation site 52, and the infrastructure at the central site 51 act accordingly and remove the duplicated or unused functionalities. If the check of block 905 reveals that the performance is not acceptable, the split controller may revert to the previous split of the protocol stack and delete newly instantiated protocol stack functionalities at the central site 51.

FIG. 10 further illustrates the selection of the site to instantiate the functionalities of the DU(s) currently implemented at the overloaded aggregation site 52. In the example of FIGS. 8A, 8B, and 8C, the selected site would be the central site 51. The procedures illustrated by FIG. 10 may be performed as sub-procedures of above-mentioned block 902.

At block 1001, the split controller identifies the sites executing the remaining protocol stack functionalities which are not being executed by the overloaded site. In the example of FIGS. 8A, 8B, and 8B, this would involve identifying the sites where the CU and the RUs are implemented. For this purpose, the split controller could receive a message from the overloaded site, indicating for each of the protocol stack functionalities being executed, the nodes or other infrastructure entities executing the remaining protocol stack functionalities. Such infrastructure entities may correspond to those which communication protocol data traffic with the infrastructure of the site with the failure. The message could for example be received immediately after the initialization of a new protocol stack or a split change, which could also be controlled by another entity than the split controller. Further, such message could be received in response to a corresponding request from the split controller. Further, the split controller could send a message to all sites, requesting to indicate whether infrastructure of the respective site executes the protocol stack functionalities which are complementary to those executed at the overloaded site.

At block 1002, the split controller determines the protocol stack functionalities executed at the relevant sites. In the considered example, these would include at least the central site 51 and the aggregation site 52. This may correspond to identifying which split option is currently being applied. For this purpose, the split controller may send a request message to the relevant sites currently executing the protocol stack functionalities and/or which are planned to execute the protocol stack functions. In some cases, the split controller may periodically send such request message, or the request message could instruct the relevant sites to periodically report the protocol stack functionalities currently being executed and/or planned to be executed. In some cases, the split controller could send a request message to the relevant sites, instructing the sites to report any changes concerning the executed protocol stack functionalities, such as new protocol stack functionalities added due to setting up of new base stations. In some cases, the split controller could also use the signaling of block 1001 to determine the protocol stack functionalities currently executed or planned to be executed by the relevant sites. In this case, the signaling of block 1001 could be supplemented by corresponding information.

At block 1003, the split controller uses the information obtained from block 1002 to determine computational requirements, memory requirements, and connectivity requirements for executing the protocol stack functionalities currently being executed at the site with the failure. In the considered example, this may involve identifying the requirements to execute at least some of the functionalities of the layers originally executed by the DU(s) at the aggregation site(s) 52, e.g., in the considered example the functionalities of the RLC layer and MAC layer. The determination of the computational and memory requirements may for example be based on a look-up table or other database available at the split controller, indicating the requirements for executing a given protocol stack layer. In some cases, the requirements may correspond to requirements to implement specifications provided by 3GPP and/or O-RAN.

The determination of the connectivity requirements may consider to a maximum latency and the minimum throughput permitted between the lowest protocol stack functionality to be executed, in the considered example the MAC layer, and the immediately lower protocol stack functionalities, in the considered example the High PHY layer. Once the involved protocol stack functions/layers are identified, the connectivity requirements may be obtained by, e.g., from a look-up table or other database. Such look-up table or database may store previously computed connectivity requirements for all possible split options.

At block 1004, the split controller requests capability information from candidate sites which could potentially execute the protocol stack functionalities of the overloaded site. If the overloaded site is an aggregation site 52, like in the illustrated example, the candidate sites could be one or more other aggregation sites 52 or one or more central sites 51. In some cases, the split controller could request the capability information from all sites. In other cases, the split controller could request the capability information from only the sites identified at block 1001. The capability information may for example indicate available computational resources and/or available memory resources, in terms of current availability and/or availability for a certain future time period. Further, the capability information may indicate latency and/or throughput of the links connecting the candidate site with the sites relevant RUs executing parts of the protocol stack, i.e., the RU sites identified at block 1001. To acquire the capability information, the split controller may send a request message to the candidate sites. In some cases, the split controller may periodically send such request message, or the request message could instruct the candidate sites to periodically report the capability information. In some cases, the split controller could send a request message to the candidate sites, instructing the sites to report any changes concerning the capability information. In some cases, the split controller could also use the signaling of block 1001 to determine the capability information. In this case, the signaling of block 1001 could be supplemented by corresponding information.

At block 1005, the split controller determines the site(s) to execute some of the protocol stack functionalities of the overloaded site and the updated split of the protocol stack. For this purpose, the split controller may first determine, for each independent protocol stack being executed at the aggregation site 52, for each of the different DUs, and for each of the possible splits of such independent protocol stack, candidate tuples of site X and protocol split Y that satisfy the minimum computational, memory, and connectivity requirements for executing protocol split Y. This identification is achieved by comparing the requirements obtained from block 1003 with the capability information obtained from block 1004. If there is only a single candidate tuple that satisfies the requirements, this candidate tuple may be selected and the selection procedure finished. If there are multiple candidate tuples that satisfy the requirements, the split controller may further select among the candidate tuples. Such further selection may be based on the following criteria: In some cases, the split controller may select the candidate tuple that will leave the largest number of available resources at the site. Here, the available resources may be computational resources, memory resources, connectivity resources, and/or a combination of two or more of such resource types. In some cases, the split controller may select the candidate tuple with the smallest economic cost. The economic cost may for example refer to current or expected monetary costs to execute the protocol stack functionalities, typically also taking into account the occupation of connectivity resources. In some cases, the split controller may select the candidate tuple that most closely resembles the current split of the protocol stack and thus minimizes the changes from the current split. In some cases, the split controller may select the candidate tuple with the smallest power consumption. In some cases, the split controller may randomly select the candidate tuple. Further, the selection could be based on a combination of two or more of the above criteria, e.g., by defining a selection metric which considers the criteria in combination, such as a weighted combination of two or more of the individual metrics underlying the criteria. In some cases, also a multi-stage selection process could be used where each stage applies a different criterion. For example, a first stage selection could involve selecting the site least prone to failure, i.e., is most reliable, and, if more than one split is feasible for this site, the split could be selected based on one of the above-mentioned criteria, e.g., resource availability, economic cost, or power consumption. A reliability metric indicting how prone to failures a site is may for example be computed by evaluating past downtimes of the sites. In some scenarios, the criterion or the criteria to be applied in the selection may be configurable, e.g., by the operator of the wireless communication network. For determination of one or more of the metrics considered in the selection, the split controller may also request additional information from the candidate sites.

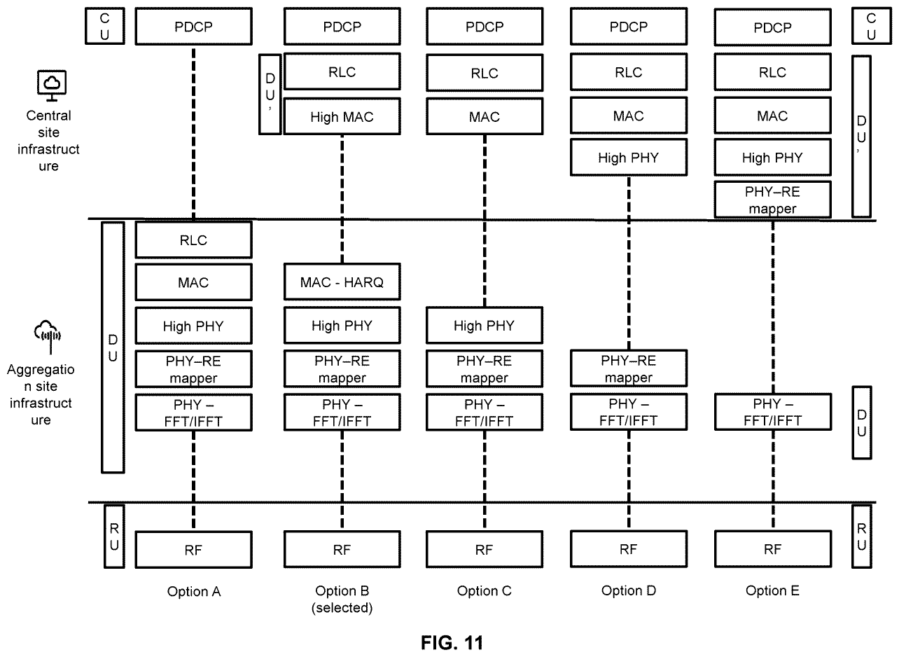

FIG. 11 illustrates a specific example of possible split options considered at block 1005. When assuming an original situation as illustrated by FIG. 8A, the split controller may first determine that there are only two feasible split options, namely Option B and Option C in of FIG. 11. This limitation of options may be due to the required throughput of the interface between the central site 51, where additional protocol stack functionalities may be executed, and the overloaded aggregation site 52. For instance, for Option D of FIG. 10, which would involve executing the High PHY layer, MAC layer, and RLC layer at the central site 51, an uplink throughput of that needs to be supported would be 15.2 Gbps which may be higher than that the throughput offered by the interface between central site 51 and aggregation site 52 (which could be only 10 Gbps). Following the above criterion to minimize the number of changes in the current split, the split controller may thus select Option C, i.e., to execute functionalities of the RLC layer and of the MAC lay at the central infrastructure, as shown in FIG. 8B.

In a third example, a scenario involving balancing of power consumption and monetary cost is considered. In particular, there may be situations where prices of computational resources may be different for different infrastructure sites and such prices may change over time. For instance, during the night, the GPU utilization in the aggregation sites 52 may be cheaper than the GPUs in the central sites 51, but the opposite case may be true during the day. Such pricing during the night can for example be due to a high usage of GPUs at the central site 51 for ML training during the night. Moreover, the hardware infrastructure of aggregation sites 52 is typically designed to cope with the most stringent requirements that occur at times with peak traffic demands, therefore reducing the resource utilization at times with reduced demands, which occur typically during the night.

Similarly, the power consumption and the carbon footprint of computational resources may be different for different infrastructure sites, and also the power consumption may vary over time. For instance, it is typically easier to implement energy efficient infrastructure at a central site 51. This may be the case, e.g., because the cooling systems of large cloud infrastructure facilities are often more efficient than those of smaller ones. Moreover, the power consumption of executing certain functionalities may also change over time since for example the power consumption does not scale linearly with the computational load and the computational resources of site infrastructure could also be used for other purposes, which are not related to operation of a wireless communication network. Furthermore, impact of energy consumption is typically time dependent. It may for example be of significant importance—or even become mandatory in the future-to save as much energy as possible when operating the infrastructure at times when energy resources are constrained.

In the third example, it is assumed that the power consumption related to executing functionalities at the central site 51 is lower than the power consumption related to executing functionalities at the aggregation site 52. It is further assumed that, for the operator of the wireless communication network, the monetary cost of executing functionalities at the central site 51 may vary over time, for example depending on the computational load of the central site 51, bearing in mind that the infrastructure of the central site 51 could also be used for other purposes, which may also be unrelated to telecommunication. It is further assumed that there are regulations, e.g., provided a regulatory body, that force operators of wireless communication networks, or telecommunication networks in general, to minimize power consumption caused by operation of their network at specific times, e.g., during peak loads on the public power grid. In such a scenario, the split controller the split controller may be configured to optimize the split of the protocol stack and the allocation of functionalities to the different sites with the aim of obtaining a balance of monetary cost and power consumption. Such optimization may be based on minimizing a cost function depending on both the monetary cost and the power consumption, e.g., given by:

C=αP+(1−a)M (1)

where P is a metric representing power consumption and/or carbon footprint, M is the monetary cost of operating the wireless communication network, which may in particular include payments to a third-party entity operating the central site 51, and a is a parameter that may be manually configured by, e.g., the network operator to bias the trade-off between power consumption and monetary cost.

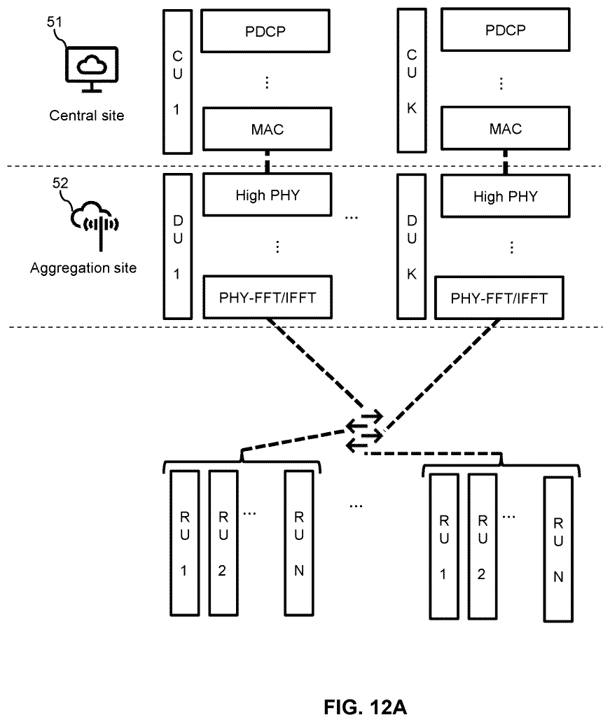

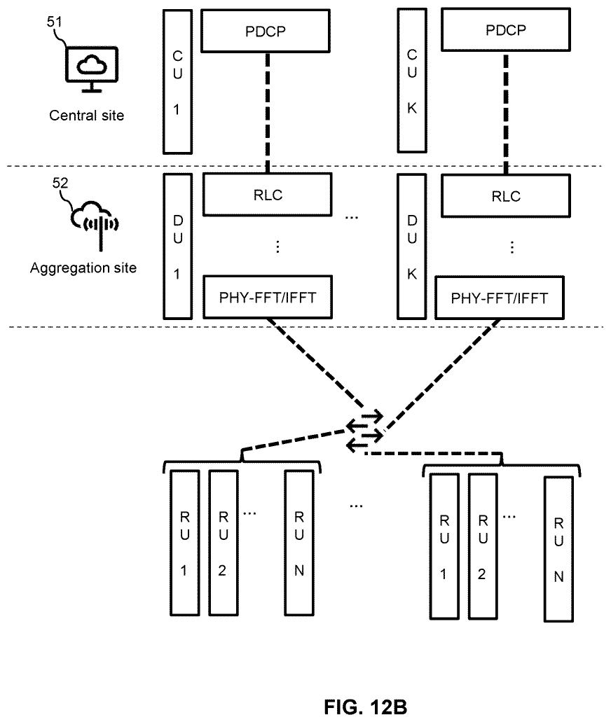

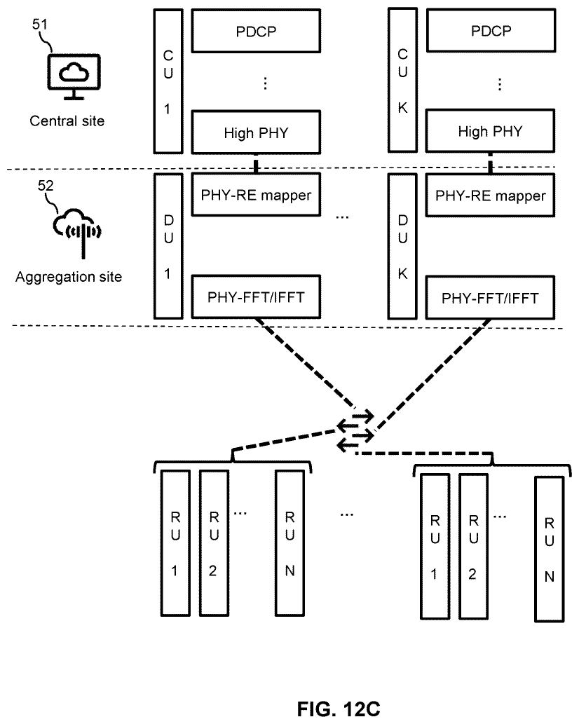

An initial situation considered by the split controller is assumed to be as illustrated in FIG. 12A. This situation may for example correspond to a default split and allocation of functionalities to sites, to be applied when there is no regulatory obligation to further minimize power consumption. In the situation of FIG. 12A, functionalities of the PHY-FFT/IFFT layer to High PHY layer are implemented by a number of DUs (denoted as DU 1-DU K) at one or more aggregation sites 52, and functionalities of the MAC layer to PDCP layer are executed by a number of CUs (denoted as CU 1-CU K) at a central site 51. Functionalities of the RF layer are located at multiple sets of RUs (each including multiple RUs denoted as RU 1-RU N). In the figure, each set of vertically aligned CU, DU and set of RUs denotes an independent protocol stack.

If there is an increase of the prices of the computational resources at the central site 51, so that the prices of the computational resources at the central site 51 become higher than the prices of the computational resources at the aggregation site 52, the split controller may react by moving some protocol stack functionalities, in particular those of the MAC layer and the RLC layer, to the aggregation site 52, as illustrated in FIG. 12B. In the situation of FIG. 12B, functionalities of the PHY-FFT/IFFT layer to RLC layer are implemented by a number of DUs (denoted as DU 1-DU K) at the one or more aggregation sites 52, and the functionalities the PDCP layer are executed by a number of CUs (denoted as CU 1-CU K) at the central site 51. Functionalities of the RF layer remain located at the RUS.

If then at some time a regulatory obligation to further minimize power consumption comes into force, the split controller may react by moving as many protocol stack functionalities as technically feasible to the central site 51, which may allow for minimizing the power consumption. This may result in a situation as illustrated in FIG. 12C. If the split controller operates on the basis of the cost function given by (1), one way to enforce such action would be to set the parameter a to a large value, e.g., to 1. In the situation of FIG. 12C, functionalities of the PHY-FFT/IFFT layer to the PHY-RE mapper are implemented by a number of DUs (denoted as DU 1-DU K) at the one or more aggregation sites 52, and the functionalities the High PHY layer to PDCP layer are executed by a number of CUs (denoted as CU 1-CU K) at the central site 51. Functionalities of the RF layer remain located at the RUs.

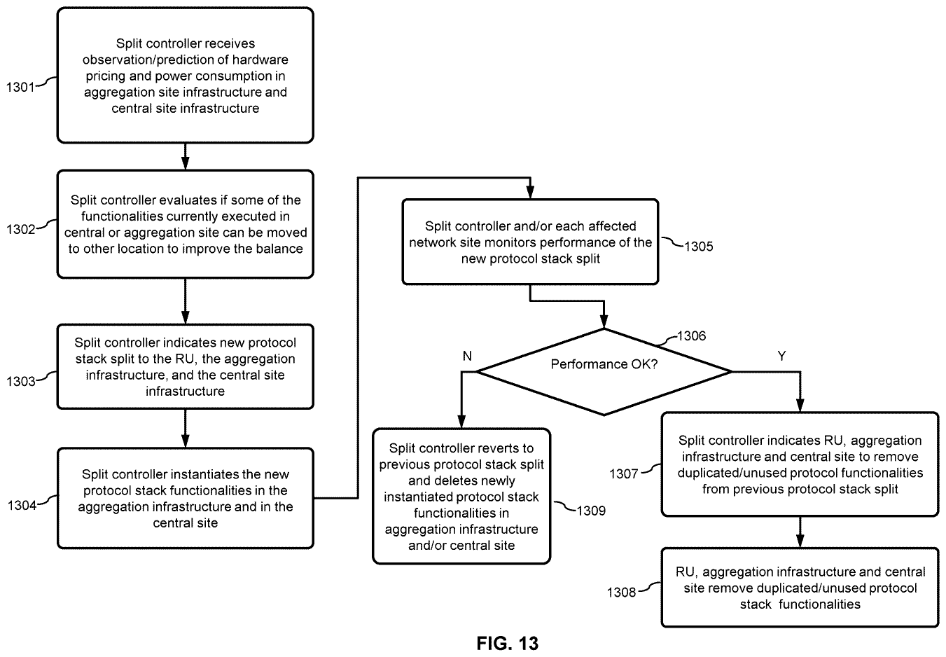

FIG. 13 schematically illustrates a procedure underlying the scenario of the third example. At block 1301 of FIG. 13, the split controller receives an observation or prediction of resource pricing and power consumption in aggregation site infrastructure and central site infrastructure. Further, the split controller may be provided with input concerning the above-mentioned parameter a. Receiving the observation or prediction may involve that the split controller periodically receives measurements of one or more KPIs related to the hardware and/or software of the relevant site infrastructure, e.g., related to current power consumption and/or pricing of the computational resources and/or of connectivity resources. The connectivity resources may refer to, e.g., the resources related to network interfaces for inter-connection of distinct protocol stack layers executed in different infrastructure entities. In some scenarios, the split controller may receive such KPI(s) in response to a request. Alternatively or in addition, infrastructure at the respective site could decide autonomously to report such KPI(s), e.g., based on a configuration provided by the split controller. Such autonomous reporting of KPI(s) could for example be performed according to a periodic schedule or be triggered when a set of one or more predetermined conditions is met, e.g., pricing of the computational resources at the respective site exceeds a threshold, or the like. In the considered example, block 1301 specifically involves identifying that the balance of pricing and power consumption may be improved by another organization of the protocol stack in terms of allocation of functionalities to the sites and/or in terms of split of the protocol layers. In some cases, such identification may be based on one or more corresponding indications from the site, e.g., based on a KPIs indicating changes of power consumption and/or changes of resource pricing.

In some scenarios, an ML model may be used to predict changes of power consumption at the sites and/or to predict changes of resource pricing. Such ML model could for example be based on a time series forecasting model. Such ML model may be similar to that as used in the first example.

Additional input, e.g., concerning parameter a, can be received from other network entities or from outside the wireless communication network. In some scenarios, such additional input can be provided by a cloud application for power consumption management.

At block 1302, the split controller evaluates if some of the functionalities of one or more DUs currently executed in aggregation infrastructure can be instantiated in central site infrastructure or if one or more CUs currently executed in central site infrastructure can be instantiated in the aggregation infrastructure. This may be accomplished in a similar manner as explained in connection with FIGS. 7 and 10, however in this case considering a rule which aims at optimizing the balance of power consumption and monetary cost. Based on such rule, the split controller determines an adapted split of the protocol stack functionalities and an adapted allocation of the protocol stack functionalities to the sites.

For determining the adapted split of protocol stack functionalities and the adapted allocation of the protocol stack functionalities to the sites, the split controller may identify, among the different possible splits and functionality allocations, those splits that allow for satisfying computational requirements, memory requirements, and connectivity, similar as explained in connection with blocks 903 to 905. If only a single combination of split and functionality allocation meets the requirements, this combination is chosen and the selection of block 1302 is finished.

If there are multiple combination of split and functionality allocation that satisfy the requirements, the split controller will select the combination that minimizes the cost function given by (1).

In the situation of FIG. 12B, the increase in pricing of computational resources at the central site 51 results in moving functionalities to the aggregation site(s) 52 even if this results in less energy efficiency than when implementing these functions at the central site 51. In the situation of FIG. 12C, however, with much stricter constraints on power saving, functionalities are moved from the aggregation site(s) 52 to the central site 51.

Also in the third example, the selection options among different splits may correspond to those as illustrated in FIG. 10. In the third example, the initial situation of FIG. 12A corresponds to Option C of FIG. 10. As the parameter M increases, the split controller decides to switch to Option A, which corresponds to the situation as illustrated by FIG. 12B. When the obligation of power saving comes into force, the parameter a is set to a high value, causing the split controller to switch to Option D, which corresponds to the situation as illustrated by FIG. 12C.

At block 1303, the split controller indicates the adapted split and functionality allocation of the protocol stack to the RUs, the infrastructure of the aggregation site 52, and the infrastructure of the central site 51, and at block 1304, the split controller instantiates protocol stack functionalities of the DU(s) in the infrastructure of the central site 51.

At block 1305, the split controller and/or each affected site may monitor performance of the adapted split and, at block 1305, check if the performance is acceptable. If the performance is found to be acceptable, the split controller may proceed to block 906, as indicated by branch “Y”. At block 1306, the split controller may instruct the infrastructure at the RU sites, the infrastructure at the aggregation site 52, and the infrastructure at the central site 51 to remove duplicated or otherwise unused protocol functionalities, which may remain from the previous split of the protocol stack. At block 1307, the infrastructure at the RU sites, the infrastructure at the aggregation site 52, and the infrastructure at the central site 51 act accordingly and remove the duplicated or unused functionalities. If the check of block 1305 reveals that the performance is not acceptable, the split controller may revert to the previous split of the protocol stack and delete newly instantiated protocol stack functionalities at the central site 51.

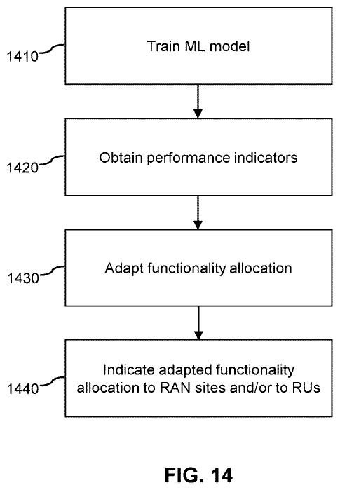

FIG. 14 shows a flowchart for illustrating a method, which may be utilized for implementing the illustrated concepts. More specifically, the method may be used to implement the above-mentioned functionalities of the split controller 180. The method of FIG. 14 may be used for implementing the illustrated concepts in a node of a wireless communication network. For example, the node may correspond to a RAN node, such as one of the above-mentioned access nodes or part thereof. In some cases, the node could correspond to a virtual node implemented by a cloud application executed on multiple physical nodes, e.g., by infrastructure of the above-mentioned central site 51 or aggregation sites(s) 52.

If a processor-based implementation of the node is used, at least some of the steps of the method of FIG. 14 may be performed and/or controlled by one or more processors of the node. Such node may also include a memory storing program code for implementing at least some of the below described functionalities or steps of the method of FIG. 14.

At step 1410, an ML model may be trained. In some cases, the ML model may be trained to predict failures at sites of the wireless communication network. Alternatively or in addition, the ML model may be trained to predict overload situations at sites of the wireless communication network. Alternatively or in addition, the ML model may be trained to predict changes in power consumption at sites of the wireless communication network. Alternatively or in addition, the ML model may be trained to predict changes in pricing of computational resources at sites of the wireless communication network.

At step 1420, performance indicators of computational resources of a plurality of sites of a RAN of the wireless communication network are obtained, e.g., as explained above for block 601 of FIG. 6, block 901 of FIG. 9, or block 1301 of FIG. 13.

The computational resources may include one or more CPUs at the considered site, one or more GPUs at the considered site, and/or one or more RAM devices at the considered site. The performance indicators may be indicative of: power consumption, resource availability, resource load, downtimes, hardware costs, device temperature, circuitry measurements, interface status, and/or software status. Alternatively or in addition, the performance indicators may be indicative of a failure at the considered site. Alternatively or in addition, the performance indicators may be indicative of an overload situation at the considered site.

In some scenarios, at least a part of the performance indicators may be received in response to a request. Alternatively or in addition, at least a part of the performance indicators may be received according to a configured schedule. Alternatively or in addition, the performance indicators may be provided in response to a triggering event at the considered site.

In some scenarios, the performance indicators obtained at step 1420, or a part of such performance indicators, may be used as training data for the ML model at step 1410.

At step 1430, a functionality allocation is adapted based on the performance indicators obtained at step 1420. The functionality allocation allocates a first set of radio access functionalities of a first set of one or more protocol layers to a first set of the sites of the wireless communication network and allocates a second set of radio access functionalities of a second set of one or more protocol layers to a second set of the sites of the wireless communication network. As explained in the above example, the first set of sites may for example include one or more aggregation sites, and the second set of sites may include one or more central sites. Each of the sites may provide the computational resources based on infrastructure at the respective site. This infrastructure may correspond to cloud infrastructure that can be used to flexibly implement processing units, e.g., one or more CUs and/or one or more DUs. Accordingly, in some scenarios, the first set of radio access functionalities may comprise at least one functionality that is distributed among multiple sites of the wireless communication network, e.g., is executed by a DU. Further, in some scenarios the second set of radio access functionalities may comprise at least one functionality that is centralized at a single site of the wireless communication network, e.g., is executed by a CU.

In some scenarios, step 1430 may further involve determining the first set of radio access functionalities and the second set of radio access functionalities based on the performance indicators obtained at step 1420. In other words, among multiple functionalities of the different protocol layers, it can be determined for which functionality the functionality allocation to the sites is to be adapted. In some cases, functionalities of a lower protocol layer can be moved to a different site, while in other cases functionalities of a higher protocol layer are moved to a different site.

In some scenarios, the adaptation of the functionality allocation at step 1430 may be based on reported capabilities of the sites, e.g., as explained in connection with blocks 704 and 104. In some scenarios, the adaptation of the functionality allocation at step 1430 may be based on an ML model, e.g., the ML model trained at step 1410.

At step 1440, the adapted functionality allocation may be indicated to the first set of sites and to the second set of sites. Further, the adapted functionality allocation may be indicated to radio units of the radio access network. In this way, the adapted functionality allocation may be enforced at the different sites of the wireless communication network.

In some scenarios, an update of one or more of the performance indicators may be obtained based on the adapted functionality allocation, i.e., once the adapted functionality allocation is applied. Based on the updated one or more performance indicators, the functionality allocation may then be further adapted, or it can be decided whether to revert to a previous version of the functionality allocation.

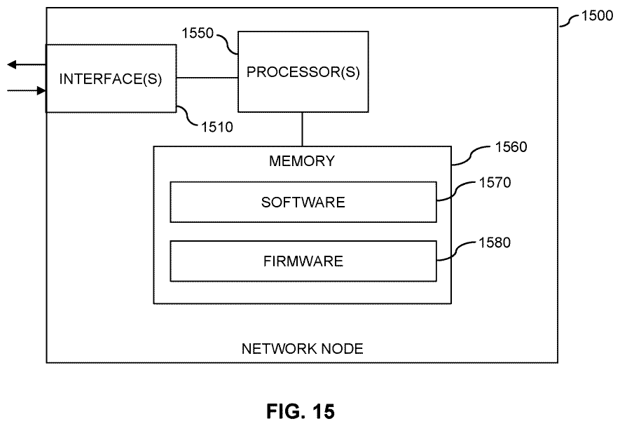

FIG. 15 illustrates a processor-based implementation of a node 1500 for a wireless communication network, which may be used for implementing the above-described concepts. More specifically, the structures of the node 1500 may be used to implement the above-mentioned functionalities of the split controller 180.

As illustrated, the node 1500 may include one or more interfaces 1510. The interface(s) 1510 may for example be used for communicating with other nodes of the wireless communication network.

Further, the node 1500 may include one or more processors 1550 coupled to the interface(s) 1510 and a memory 1560 coupled to the processor(s) 1550. By way of example, the interface(s) 1510, the processor(s) 1550, and the memory 1560 could be coupled by one or more internal bus systems of the node 1500. The memory 1560 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1560 may include software 1570 and/or firmware 1580. The memory 1560 may include suitably configured program code to be executed by the processor(s) 1550 so as to implement or configure the above-described functionalities for adaptation of allocation of functionalities of protocol layers to network sites, such as explained in connection with FIG. 14.

It is to be understood that the structures as illustrated in FIG. 15 are merely schematic and that the node 1500 may actually include further components which, for the sake of clarity, have not been illustrated, e.g., further interfaces or further processors. Also, it is to be understood that the memory 1560 may include further program code for implementing known functionalities of RAN nodes or other nodes of a wireless communication network. According to some embodiments, also a computer program may be provided for implementing functionalities of the node 1500, e.g., in the form of a physical medium storing the program code and/or other data to be stored in the memory 1560 or by making the program code available for download or by streaming. Further, it is noted that in some scenarios multiple nodes 1500 with structures as illustrated in FIG. 15 could be used in combination, e.g., as a cloud system, to implement the above-described functionalities for adaptation of allocation of functionalities of protocol layers to network sites, such as explained in connection with FIG. 14.

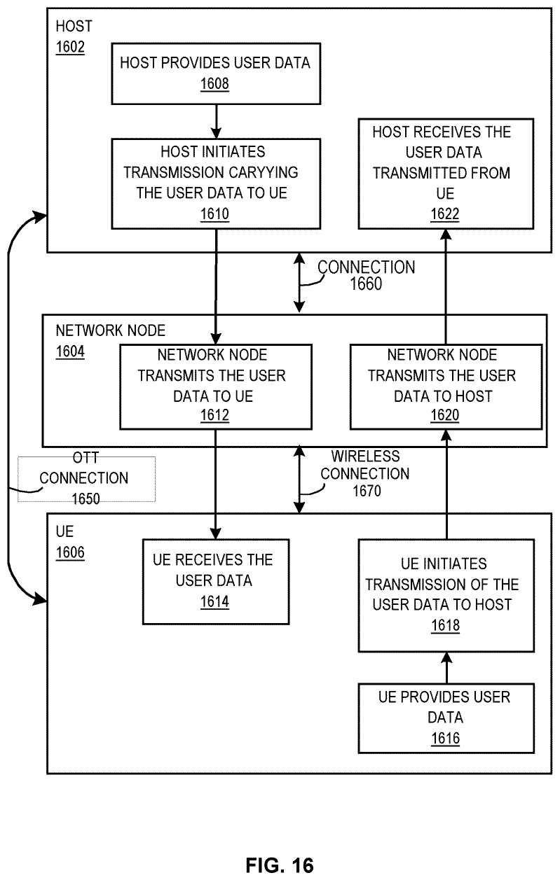

FIG. 16 shows a communication diagram of a host 1602 communicating via a network node 1604 with a UE 1606 over a partially wireless connection in accordance with some embodiments. Example implementations, in accordance with various embodiments, of the UE (such as one of the above-mentioned UEs 10), network node (such as one of the above-mentioned base stations), and host (such as the above-mentioned service platform 150 or application server(s) 160) will now be described with reference to FIG. 16.

Embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 110 of FIG. 4) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

The illustrated concepts may help to improve, performance of OTT services provided to the UE 1606 using the OTT connection 1650, in which the wireless connection 1670 forms the last segment. More precisely, the teachings of these embodiments may allow for providing the wireless connection 1670, and thus also the OTT connection, in a resource efficient manner, dynamically taking into account variable conditions related to computational resources of infrastructure for implementing the RAN.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc. ; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

As can be seen, the concepts as described above may be used for efficiently controlling operation of a wireless communication network with respect to allocation of RAN functionalities of different protocol layers to different infrastructure sites. The illustrated concepts may provide benefits in various scenarios, without limitation to the above described first example, second example, and third example. For example, the illustrated concepts may help to reduce network operation downtime, e.g., by moving protocol stack functionalities to functional sites upon detection or prediction of a failure in one or more sites, e.g., like in the first example. Further, the illustrated concepts may help to achieve improved utilization of infrastructure resources, e.g., by moving protocol stack functionalities to prevent overloading in specific sites, e.g., like in the second example. Further, the illustrated concepts may help to reduce power consumption, e.g., by moving protocol stack functionalities to sites with lower pricing of resources, e.g., like in third example. Further, the illustrated concepts may help to reduce network operation cost, e.g., by moving protocol stack functionalities to sites with lower pricing of resources, e.g., like in third example. It is further noted that such exemplary usages of the illustrated concepts could also be combined, e.g., by optimizing a balance of power consumption and monetary cost, e.g., like in third example, or by combining consideration of potential failures and overload situations at the sites.

It is to be understood that the examples and embodiments as explained above are merely illustrative and susceptible to various modifications. For example, the illustrated concepts may be applied in connection with various kinds of wireless communication technologies. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling operation of a wireless communication network, the method comprising:
obtaining performance indicators of computational resources of a plurality of sites of a radio access network of the wireless communication network;
based on the performance indicators, adapting a functionality allocation allocating a first set of radio access functionalities of a first set of one or more protocol layers to a first set of the sites of the wireless communication network and allocating a second set of radio access functionalities of a second set of one or more protocol layers to a second set of the sites of the wireless communication network.

2. The method according to claim 1, wherein the first set of radio access functionalities comprises at least one functionality that is distributed among multiple sites of the wireless communication network.

3. The method according to claim 1, wherein the second set of radio access functionalities comprises at least one functionality that is centralized at a single site of the wireless communication network.

4. The method according to claim 1, comprising:
determining the first set of radio access functionalities and the second set of radio access functionalities based on the performance indicators.

5-7. (canceled)

8. The method according to claim 1, wherein the performance indicators are indicative of: power consumption, resource availability, resource load, downtimes, hardware costs, device temperature, circuitry measurements, interface status, and/or software status.

9. The method according to claim 1, wherein the performance indicators are indicative of a failure at the considered site.

10. The method according to claim 1, wherein the performance indicators are indicative of an overload situation at the considered site.

11. The method according to claim 1, comprising:
receiving at least a part of the performance indicators in response to a request.

12. The method according to claim 1, comprising:
receiving at least a part of the performance indicators according to a configured schedule.

13. The method according to claim 1, wherein at least some of the performance indicators are provided in response to a triggering event at the considered site

14. The method according to claim 1, comprising:
indicating the adapted functionality allocation to the first set of sites and to the second set of sites.

15. The method according to claim 1, comprising:
indicating the adapted functionality allocation to radio units of the radio access network.

16. The method according to claim 1, comprising:
based on the adapted functionality allocation, obtaining an update of one or more of the performance indicators.

17. (canceled)

18. The method according to claim 16, comprising:
based on the updated one or more performance indicators, deciding whether to revert to a previous version of the functionality allocation.

19. The method according to claim 1, wherein said adapting of the functionality allocation is based on a machine learning model.

20. The method according to claim 1, wherein the machine learning model is trained to predict failures at the sites.

21. The method according to claim 1, wherein the machine learning model is trained to predict overload situations at the sites.

22. The method according to claim 1, wherein said adapting of the functionality allocation is based on reported capabilities of the sites.

23. A node for a wireless communication network, the node being configured to:
obtain performance indicators of computational resources of a plurality of sites of a radio access network of the wireless communication network;
based on the performance indicators, adapt a functionality allocation allocating a first set of radio access functionalities to a first set of the sites of the wireless communication network and allocating a second set of radio access functionalities to a second set of the sites of the wireless communication network.

24-25. (canceled)

26. A computer program product comprising program code to be executed by at least one processor of a node of a wireless communication network, whereby execution of the program code causes the node to perform a method according to claim 1.
